(19) United States
(12) Patent Application Publication
(10) Pub. No.: US 2020/0039401 A1
(43) Pub. Date: Feb. 6, 2020

(54) AUTOMOBILE SEAT COVER SYSTEM

(71) Applicants: Julio Enrique Mestroni, Kennesaw, GA (US); Vijay Anand Raghavendran Nenmeni, Alpharetta, GA (US); Gregory James Boncimino, Marietta, GA (US)

(72) Inventors: Julio Enrique Mestroni, Kennesaw, GA (US); Vijay Anand Raghavendran Nenmeni, Alpharetta, GA (US); Gregory James Boncimino, Marietta, GA (US)

(73) Assignees: Julio Enrique Mestroni, Kennesaw, GA (US); Vijay Anand Raghavendran Enrique Nenmeni, Alpharetta, GA (US); Gregory James Boncimino, Marietta, GA (US)

(21) Appl. No.: 16/532,356

(22) Filed: Aug. 5, 2019

Related U.S. Application Data
(60) Provisional application No. 62/714,080, filed on Aug. 3, 2018.

(51) Int. Cl. B60N 2/60

(52) U.S. Cl. CPC B60N 2/6027; B60N 2/6036

(57) ABSTRACT

Certain embodiments may include systems and methods for a protective automobile seat cover system. According to one embodiment of the disclosure, a protective cover assembly for an automobile seat can be provided. The protective cover assembly may include a cover pad for an automobile seat contoured to fit the automobile seat. In an example embodiment of the disclosure, the cover pad may have a top layer, a bottom layer, a top end, and a bottom end. The cover pad may further include an opening for an automobile seat headrest. The assembly may further include a dispenser attached to the automobile seat and configured to store and dispense the cover pad. The dispenser may include a slit configured to allow a user to retrieve and deploy the cover pad. The protective cover assembly may further include an attachment mechanism to attach the dispenser to the automobile seat.

### CROSS-REFERENCE TO RELATED APPLICATIONS

This application claims the benefit of U.S. Provisional Application No. 62/714,080, which was filed on Aug. 3, 2018.

### INCORPORATION BY REFERENCE

U.S. Provisional Application No. 62/714,080, which was filed on Aug. 3, 2018, is hereby incorporated by reference for all purposes as if presented herein in its entirety.

### FIELD OF DISCLOSURE

Embodiments of this disclosure generally relates to seat protection, and more specifically, to systems and methods for an automobile seat cover system.

### BACKGROUND

Automobile seats, such as those of cars, minivans, pickup trucks, and SUVs, may pick up dirt, sweat and germs when people sit on them after any strenuous activity. For instance, when runners return to their car after a run and sit down directly on the car seat, they may spoil their car seat. Parents may have similar experience when their kids return from a soccer game or any other outdoor physical activity and enter their car. Car seat covers with limited means of securing to the car seat may prove too uncomfortable and cumbersome to use. Also, some people may just use towels to protect their car seats which may not ultimately prevent sweat from penetrating the seat. Reusable and washable car seat protectors may need to be frequently washed and may not look as elegant as the original seat fabric or leather. Non-biodegradable materials used for disposable car seat covers may also create an environmental hazard during disposal.

### BRIEF DESCRIPTION OF THE DISCLOSURE

Some or all of the above needs and/or problems may be addressed by certain embodiments of the disclosure. Certain embodiments may include systems and methods for an automobile seat cover system. According to one embodiment of the disclosure, a protective cover assembly for an automobile seat can be provided. The assembly may include a cover pad for an automobile seat contoured to fit the automobile seat. In an example embodiment of the disclosure, the cover pad may have a top layer, a bottom layer, a top end, and a bottom end. The cover pad may further include an opening for an automobile seat headrest. The assembly may further include a dispenser attached to the automobile seat and configured to store and dispense the cover pad. The dispenser may include a slit configured to allow an user to retrieve and deploy the cover pad. The assembly may further include an attachment mechanism to attach the dispenser to the automobile seat.

According to another embodiment of the disclosure, a method may be provided. The method may include attaching a cover pad dispenser to an automobile seat. The cover pad dispenser may be configured to store and dispense a cover pad, where the cover pad may have an absorbent top layer, a waterproof bottom layer, a top end, and a bottom end. The cover pad may further include an opening for an automobile seat headrest. The cover pad dispenser may include a slit configured to allow an user to retrieve and deploy the cover pad. The method may further include deploying the cover pad from the cover pad dispenser and extending the cover pad over the automobile seat until an opening at the top end of the cover pad inserts into the head rest of the automobile seat.

According to another embodiment of the disclosure, a method may be provided. The method may include forming a hollow cylindrical base tube and forming one or more slits in the hollow cylindrical base tube, where the one or more slits may be configured to allow an user to retrieve and deploy a cover pad for an automobile seat. The method may further include covering the hollow cylindrical base tube with one or more layers of material to form a cover pad dispenser, the one or more layers of material may be configured to match the one or more slits in the hollow cylindrical base tube. The method may further include attaching one or more guides to the cover pad dispenser, where the one or more guides may be configured to allow straps to pass through them, the straps and guides forming an attachment mechanism to attach the cover pad dispenser to the automobile seat. The method may further include attaching end caps to both ends of the hollow cylindrical base tube and covering the end caps with the one or more layers of material.

Other embodiments, features, and aspects of the disclosure will become apparent from the following description taken in conjunction with the following drawings.

### BRIEF DESCRIPTION OF THE DRAWINGS

The detailed description is described with reference to the accompanying figures. The use of the same reference numbers in different instances in the description and the figures may indicate similar or identical items.

FIG. 1 illustrates an example automobile seat cover system in accordance with certain embodiments of the disclosure.

FIGS. 2A, 2B, and 2C illustrate example automobile seat cover systems installed on automobile seats in accordance with certain embodiments of the disclosure.

FIG. 3 illustrates an example automobile seat cover in accordance with certain embodiments of the disclosure.

FIGS. 4A and 4B illustrates an example automobile seat cover with folded side wings and in a rolled configuration, respectively, in accordance with certain embodiments of the disclosure.

FIGS. 5A-5E illustrate example automobile seat covers in accordance with certain embodiments of the disclosure.

FIGS. 6A-6H illustrate example attachment mechanisms and openings or slits for cover pad deployment in dispensers for an automobile seat cover system in accordance with certain embodiments of the disclosure.

FIG. 7A and FIG. 7B illustrate isometric views of an example dispenser for a automobile seat cover system in accordance with certain embodiments of the disclosure.

FIG. 8 illustrates an example packaging box for a automobile seat cover system in accordance with certain embodiments of the disclosure.

FIG. 9 illustrates example dispenser shapes for an automobile seat cover system in accordance with certain embodiments of the disclosure.

FIGS. 10A and 10B illustrate example dispenser configuration for an automobile seat cover system in accordance with certain embodiments of the disclosure.

FIG. 11 illustrates example dispenser attachment mechanisms for an automobile seat cover system in accordance with certain embodiments of the disclosure.

FIG. 12 illustrates example seat cover payout mechanisms for an automobile seat cover system in accordance with certain embodiments of the disclosure.

FIG. 13 illustrates use as a wearable warming accessory for an automobile seat cover in accordance with certain embodiments of the disclosure.

FIGS. 14A and 14B illustrate a method of constructing a dispenser for an automobile seat cover system in accordance with certain embodiments of the disclosure.

FIGS. 15A-15E illustrate a method of constructing a dispenser for an automobile seat cover system in accordance with certain embodiments of the disclosure.

FIG. 16 illustrates an example process for an automobile seat cover system in accordance with certain embodiments of the disclosure.

FIG. 17 illustrates an example process for an automobile seat cover system in accordance with certain embodiments of the disclosure.

### DETAILED DESCRIPTION

### Overview

The following detailed description includes references to the accompanying drawings, which form part of the detailed description. The drawings depict illustrations, in accordance with example embodiments. These example embodiments, which are also referred to herein as “examples,” are described in enough detail to enable those skilled in the art to practice the present subject matter. The example embodiments may be combined, other embodiments may be utilized, or structural, logical, and electrical changes may be made, without departing from the scope of the claimed subject matter. The following detailed description is, therefore, not to be taken in a limiting sense, and the scope is defined by the appended claims and their equivalents. Like numbers refer to like elements throughout.

Automobile seats are typically made of fabric or leather. Most automobile owners want to maintain the condition and appearance of their automobile seats at all times. This is a challenge for automobiles which are frequently used by people who are active, such as, for example, runners, bikers, and so on. Automobile owners with active kids face a similar challenge every time they pick up theirs kids and their kids' friends from an activity, for example, from a soccer game or such similar activity. Entering an automobile after an outdoor or indoor physical activity may bring with it sweat and/or dirt that may affect the condition and appearance of the automobile seats.

Certain embodiments described herein relate to systems and methods for a disposable automobile seat cover system. For example, as will be described in greater detail herein, a disposable protective cover assembly for an automobile seat may be disclosed. The assembly may include a cover pad for an automobile seat contoured to fit the automobile seat. In an example embodiment of the disclosure, the cover pad may have an absorbent top layer, a waterproof bottom layer, a top end, and a bottom end. The assembly may further include an anti-slip band disposed along a width of the cover pad and configured to reduce slippage of the cover pad from the automobile seat. The assembly may further include a cover pad dispenser attached to a head rest of the automobile seat and configured to store and dispense the cover pad.

One or more technical effects associated with certain embodiments herein may include, but are not limited to, providing a convenient means of storing and retrieving automobile seat covers. Certain embodiments herein may also have a technical effect of providing an environmentally healthy solution for environmentally conscious people. Certain other embodiments herein may also have a technical effect of minimizing effort and time taken to use a protective seat cover for an automobile. Certain other embodiments herein may also have a technical effect of preserving an appearance of the interior of the automobile. The following provides detailed description of various example embodiments related to systems and methods for a disposable automobile seat cover system.

### Example Implementations

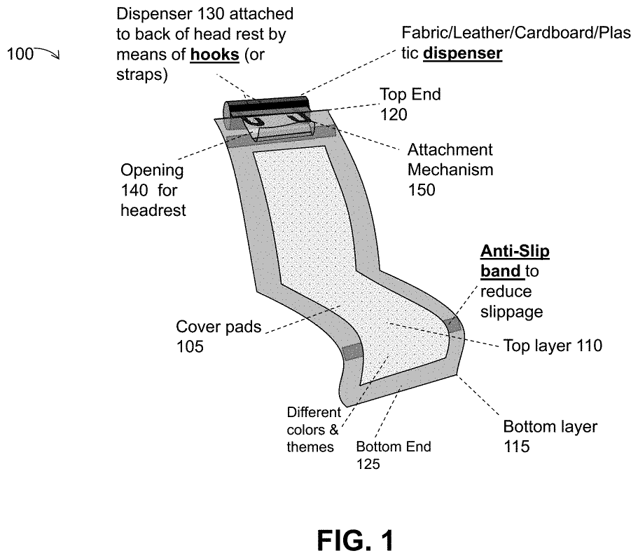

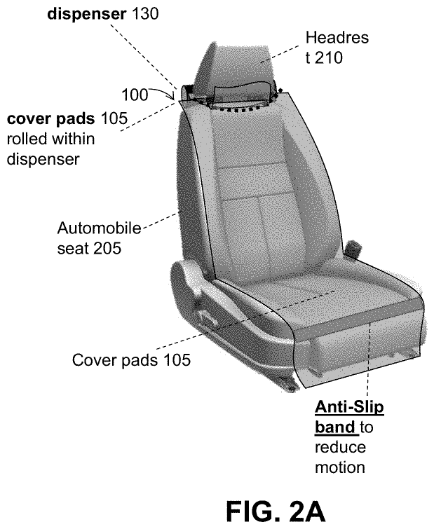

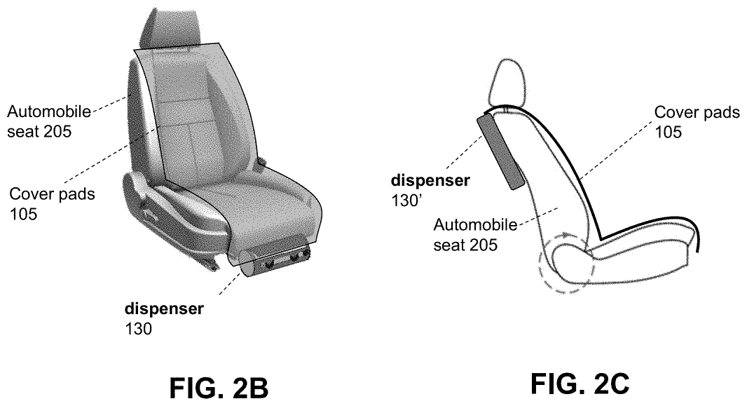

FIG. 1 illustrates an example system to implement certain systems and methods for a automobile seat cover system. According to an example embodiment of the disclosure, a protective cover assembly 100 for an automobile seat 205 (of FIG. 2) may be disclosed. The assembly 100 may include a cover pad 105 for an automobile seat 205 contoured to fit the automobile seat 205, the cover pad 105 having a top layer 110, a bottom layer 115, a top end 120, and a bottom end 125. The assembly may further include a dispenser 130 attached to a automobile seat 205 and configured to store and dispense the cover pad 105. It may be appreciated that FIG. 1 may not be drawn according to scale, and that the components of the automobile seat cover system may be larger or smaller than those indicated in the figures. Also, FIG. 1 indicated the cover pad dispenser 130 attached to a backside of an automobile headrest 210. In other embodiments of the disclosure, the cover pad dispenser 130 may be attached to a different location of the automobile seat (for instance, directly to an automobile seat if there is no head rest) or in a different orientation with respect to the automobile headrest 210. In another embodiment of the disclosure, the dispenser 130 may be attached to a different part of the automobile seat. As indicated in FIG. 1, one or more anti-slip bands may be disposed along a width or along a length of the cover pad 105 and configured to reduce slippage of the cover pad 105 from the automobile seat 205. Even though only two anti-slip bands are illustrated in FIG. 1, fewer or more anti-slip bands may be employed.

Again referring to FIG. 1, an opening 140 in the cover pad 105 at the top end 120 configured to align with the head rest 210 of the automobile seat 205 is depicted. The opening 140 may have many different shapes, such as, for example, a semi-circular opening, a rectangular opening, a “plus-shaped” opening, and so on. It may be envisioned that, depending on the configuration and type of headrest found in different automobiles, the opening 140 may be configured in a variety of shapes and sizes. In an example embodiment, the cover pad 105 may be made of a biodegradable material. Biodegradable material may include, for example, Bamboo Rayon, Wood pulp, and so on and so forth. In other embodiments, the cover pad 105 may be made of non-biodegradable materials, such as poly paper or other synthetic materials. Referring again to FIG. 1, according to an example embodiment of the disclosure, the cover pad dispenser 130 may be configured to be attached to the head rest 210 of the automobile seat 205 by an attachment mechanism 150, which may be at least one of: hooks or straps. The straps may be of elastic or inelastic type straps that secure the dispenser 130 to the automobile seat 205. The example configuration depicted in FIG. 1 shows the cover pad dispenser 130 attached to the head rest by way of hooks.

In an embodiment, the cover pad 105 may be made of a single layer, where the top layer 110 and the bottom layer 115 are combined to form a single layer. The single layer may have absorbent and water proof characteristics that ensure that the moisture from an user does not affect the fabric of the car seat. In another example embodiment, the top layer 110 of the cover pad 105 may be made of an absorbent material and the bottom layer 115 of the cover pad 105 may be made of a water proof material. In this way, the top layer 110 may adsorb sweat, dirt and other material from the user and the bottom layer 115 may ensure that those material don't reach the automobile seat, keeping the automobile seat in good condition.

In the embodiment illustrated in FIG. 1, the cover pad dispenser 130 may be capable of holding more than one cover pad 105. The cover pads 105 may be in a rolled configuration in this example. In an example embodiment, the cover pad dispenser 130 may hold 5 cover pads 105. In other example embodiments, the cover pad dispenser 130 may hold fewer or more cover pads, for example, the cover pad dispenser may hold 10, 15, 20 or 50 cover pads 105.

FIG. 2 illustrates an example seat cover assembly 100 installed on the headrest 210 of an automobile seat 205. The automobile seat 205 shown here is a front bucket seat for reference. The automobile seat may have different shapes and configurations, for example, a continuous back seat, a manual reclining seat, an automatic reclining seat, and so on. The cover pad 105 may be installed on any type of automobile seat. The cover pad 105 and the protective cover assembly may also be installed in other example locations, such as, adjacent to a message table, for use at a restaurant, for a baby high chair, and so on and so forth.

In an embodiment of the disclosure, FIGS. 2A and 2B show alternate configurations. FIG. 2B depicts a dispenser 130 mounted at the bottom of the automobile seat 205. FIG. 2C is a side view of a dispenser 130 mounted behind the automobile seat 205. In this case, the dispenser 130 is of a rectangular prism shape.

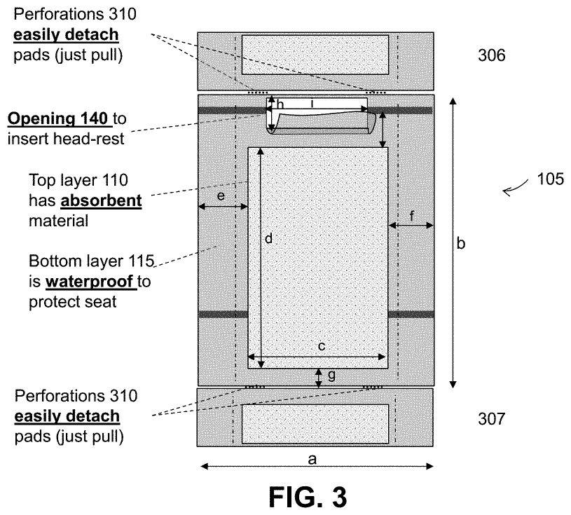

FIG. 3 shows an exploded view of an example cover pad 105. As indicated, the cover pad 105 may have perforations 310 at the top end and perforations 310 at the bottom end to detach from second and third cover pads 306 and 307 respectively. In other embodiments of the disclosure, the perforations 310 may extend all the way along the width a of the cover pad 105. In FIG. 3, the opening or cut 140 is indicated where the headrest 210 of the automobile seat 205 may be inserted. The dimensions of the opening 140 may be indicated as h by i. The dimensions for h and I depend on the type of automobile or seat that the seat cover assembly 100 or the seat cover 105 is attached to. The shape and size of the opening 140 shown here is by way of an example only. In other embodiments, the opening may have a circular, oval or any other suitable shape.

Referring again to FIG. 3, the cover pad 105 may include top layer 110 that does not extend the entire length a or the entire width b of the cover pad 105. The top layer may have dimensions d by c as indicated in FIG. 3. Likewise, the bottom layer 115 may or may not extend the entire width a of the cover pad 105. FIG. 3 depicts a bottom layer 115 that extends across the entire cover pad 105 width a. Also, the protective cover assembly 100 may include cover pad 105 that do not have one or more layers, such as the top layer 110 or the bottom layer 115. The cover pad 105 may also have a single layer that includes functions of the top layer 110 and the bottom layer 115. The cover pad 140 may be made of biodegradable material. The cover pad 140 may also be made of synthetic poly paper, hospital paper, paper towel paper, and so on and so forth.

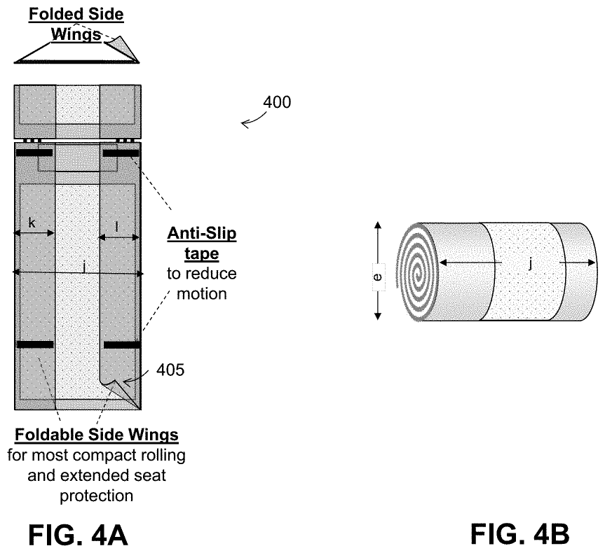

Referring now to FIGS. 4A and 4B, example configurations of folding and rolling the cover pad 105 are respectively depicted. FIG. 4A shows an example cover pad 105with foldable side wings 405. The foldable side wings 405 may allow the cover pads to be compactly stored in the cover pad dispenser 130. The width of the foldable side wings may depend on the size of the automobile seat 205 or the desired compactness of the cover pad dispenser 130. For instance, as indicated, the side wings (panels) may be folded by distances k and 1, such that the width of the rolled cover pad is j. FIG. 4B shows a rolled cover pad with a diameter e and length or width j. While a single cover pad in rolled configuration is indicated in FIGS. 4A and 4B, several covers pads 105 may be rolled together and packaged in a roll. In the embodiment illustrated in FIGS. 4A and 4B, the absorbent top layer may substantially cover the width j of the rolled cover pad 105. In other embodiments, the absorbent top layer may cover a lesser or larger portion of the rolled cover pad 105.

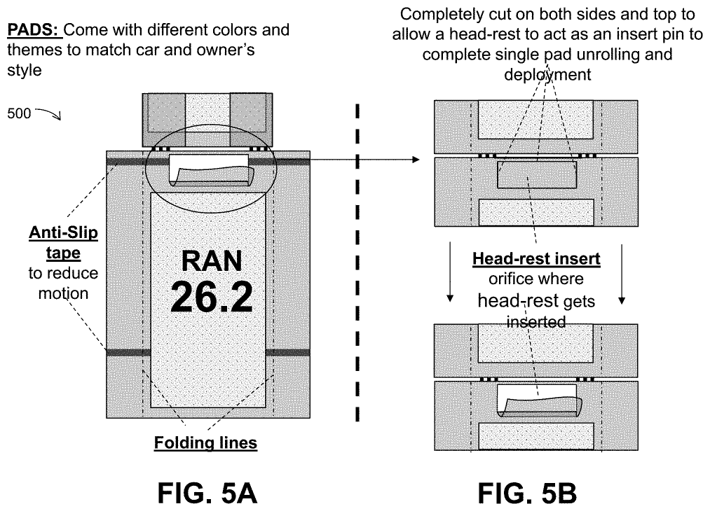

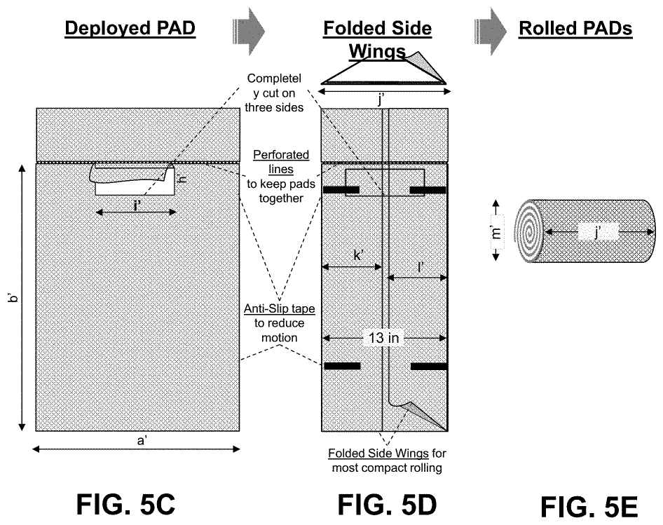

FIG. 5A and FIG. 5B respectively illustrate another example cover pad 500 and an exploded view of the opening 140. As indicated, the cover pad 500 may come in different colors and themes to match the automobile and the owner's/user's style and preferences. As an example, if the user is a triathlete, they may choose to display 26.2. The exploded view of the opening in FIG. 5B illustrates how the opening may be cut to allow the heat rest of the automobile to be inserted.

Referring now to FIG. 5C, 5D, and 5E, another example cover pad 105 is shown, where the cover pad 105 has a single layer. The single layer may have absorbent and water resistant features or may have only one of the absorbency and water proofing feature. As indicated in FIG. 5D and FIG. 5E, the cover pad 105 may be compactly rolled such that it has a length (or width) j′ and diameter m′.

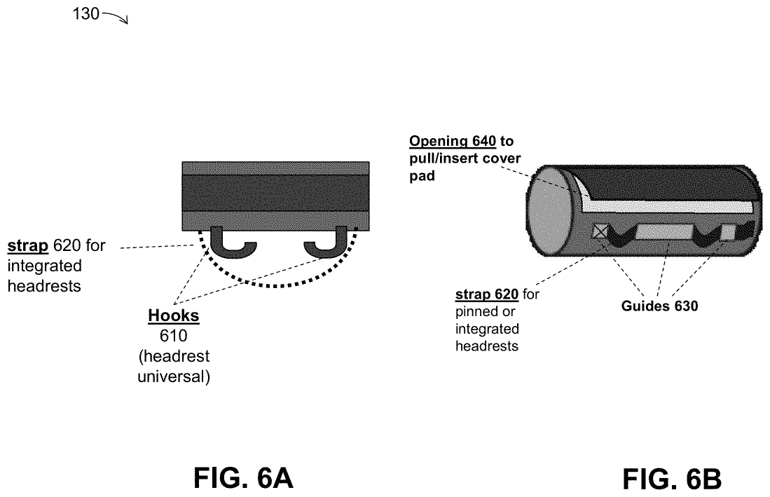

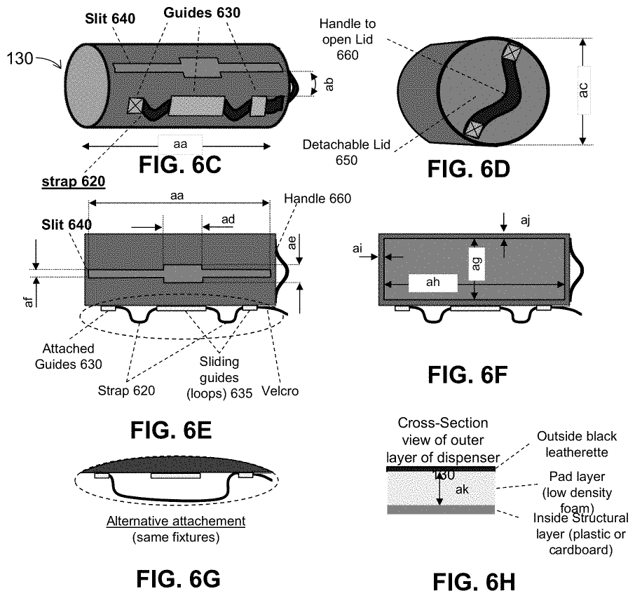

FIGS. 6A and 6B illustrates example attachment mechanisms for the dispenser 130. Example methods of attaching the cover pad dispenser 103 to the headrest 210 (not shown in FIG. 6) include attachment via hooks 610 or via straps 620. In the example depicted in FIG. 6A, hooks 610 may wrap around the posts on automobile head rest so that the dispenser is securely attached to the head rest. The strap 620 indicated in FIG. 6A may be utilized for automobiles that don't have head rest posts and have integrated head rest with their seats. This may especially be important in headrests that are integrated with the car seat and form a single structure. In the example embodiment of FIG. 6B, the straps 620 may be attached to fixed and moving guides that ensure fit against the posts of the automobile headrest. The loose end of the strap 620 in FIG. 6B may include Velcro to allow the strap 620 to be looped around and securely fastened once the automobile headrest pins are looped into the straps 620.

FIG. 6B also indicates an opening or slit 640 that may allow an user of the protective cover assembly to retrieve the cover pads 105 from the dispenser 130. While the opening 640 is shown by way of a rectangular slit, there may be other shapes and configurations as described below.

It may be appreciated that the cover pad dispensers 130 with the cover pads 105 when installed in the back of a headrest of an automobile seat may also provide additional safety and cushioning to passengers that are located behind the cover pad dispenser in case of accidents. This may make the cover pad dispenser even more attractive to potential buyers.

FIGS. 6C through 6H show example embodiments of the dispenser 130. FIG. 6C shows the orientation of an example slit 640 that may be formed on the dispenser 130 for a user to access the one or more cover pads 105 stored inside the dispenser 130. The shape, size and orientation of the slit 640 on the dispenser 130 with respect to the strap 620 may be varied to suit the needs of the user and/or the installation location.

FIG. 6D shows a dispenser 130 with a detachable lid 650, wherein the lid includes a handle 660 made of a material similar to the strap 620. FIG. 6E shows a top view of the dispenser 130, showing the slit 640, the straps 620, attached guides 630, sliding guides 635, Velcro attachment as well as the detachable lid 650 with the handle 660.

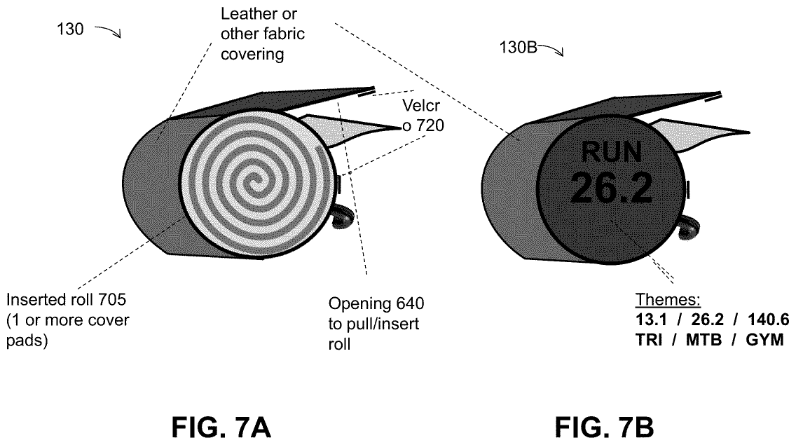

FIG. 7A and FIG. 7B illustrate perspective side views of example cover pad dispensers 130 and 130B. Referring now to FIG. 7A, a perspective side view of the cover pad dispenser 130 is indicated with an inserted roll 705 of cover pads 105. Also illustrated is an opening 710 or slit formed on the cover pad dispenser 700A that may be utilized to pull the roll of cover pads, and one or more Velcro attachments 720 that may be used to close the opening 710. In an example embodiment of the disclosure, in order to use the cover pads, a user of an automobile may detach the Velcro 720 attachments in the cover pad dispenser, retrieve a cover pad 105 from the cover pad dispenser by pulling the cover pad 105 and overlay the cover pad 105 on a car seat. Also indicated in FIG. 7A and FIG. 7B are possible texture and fabric configurations as covering for the cover pad dispenser, so that the cover pad dispenser may blend with the surroundings of the car. For example, if the cover seat dispenser is planned to be installed in a car with black leather seats, the cover pad dispenser can be made of a covering with black leather, so that the cover pad dispenser presents an elegant solution to a messy problem. Referring now to FIG. 7B, a perspective view of another cover pad dispenser 130B is illustrated, indicating a side cover for the cover pad dispenser that could be configured with a variety of themes, such as, for example, 13.1 for Half-Marathon, 26.2 for Marathon runners, and so on.

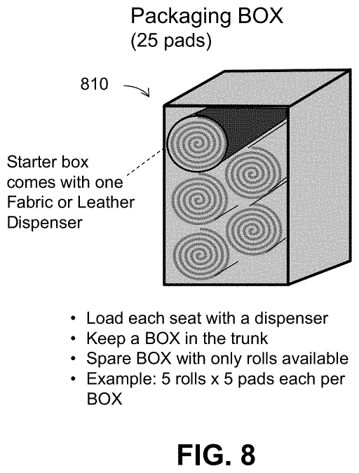

FIG. 8 illustrates an example packaging box for storing multiple rolls 705 of cover pads 105. In an example embodiment of the disclosure, the packaging box may be stored in a trunk of the car, while each seat of the car may be fitted with a cover pad dispenser 130. For example, each packaging box could hold 5 cover pad dispensers, each holding 5 rolls of cover pads. The numbers indicated here are by way of example only and shall be not considered to be limiting the scope of the disclosure.

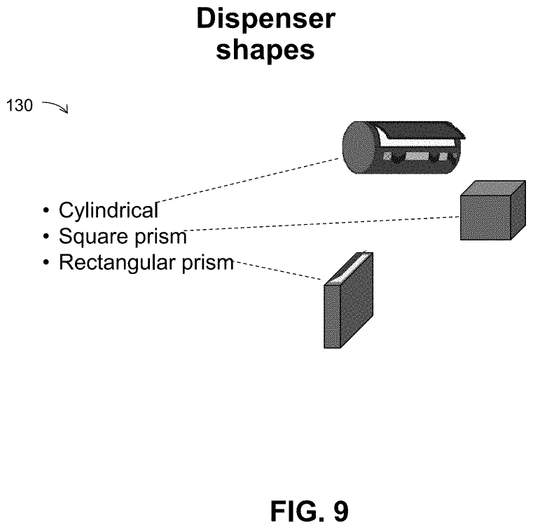

Referring now to FIG. 9, example shapes of cover pad dispenser 130 are illustrated. For example, the cover pad dispenser could be of cylindrical shape, as depicted in FIGS. 1, 7A, 7B, and 8. In other embodiments of the disclosure, the cover pad dispenser may be of a square prism shape or of a rectangular prism shape, as depicted in FIG. 9.

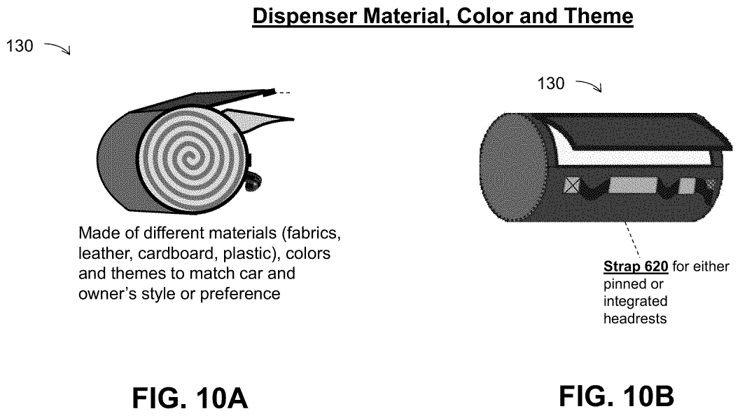

FIGS. 10A and 10B illustrate a cylindrical cover pad dispenser 130 that may be configured to have different covering material (for example, leather, fabric, cardboard, plastic, and so on), colors, and/or themes based on the configuration of the car and the user's or owner's style and preferences.

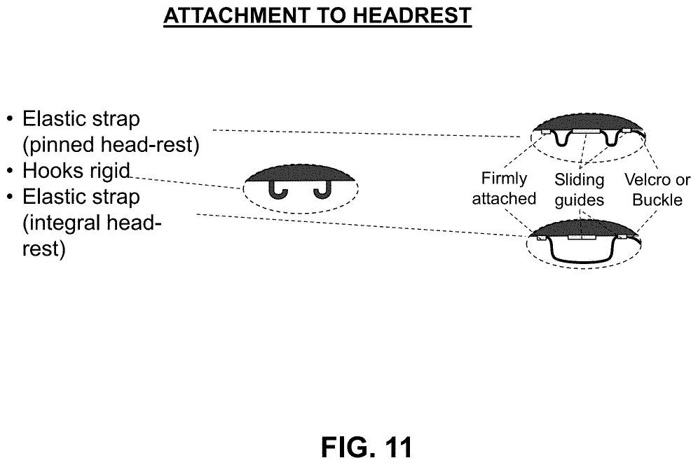

Referring now to FIG. 11, various attachment configurations for attaching the cover pad dispenser 130 to the headrest of the automobile are illustrated. As depicted in FIGS. 1 and 6, rigid hooks may be used to attach the cover pad dispenser 130 to the car seat headrest. Another example attachment may be an elastic strap that may be configured to encapsulate an integral heat rest of a car seat or one or more elastic straps that attach to a pinned head rest as indicated in FIG. 11.

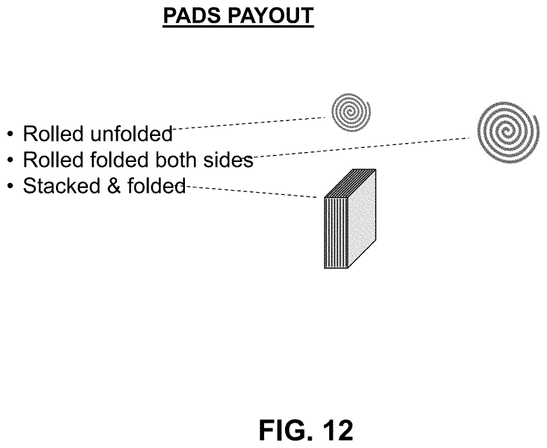

FIG. 12 illustrates different payout configurations for the cover pads. As an example, the cover pads may be rolled without being folded. In another example embodiment, the cover pads may be folded on both sides as illustrated in FIG. 4 using foldable side wings and then rolled. In other example embodiments, the cover pads may be stacked and folded.

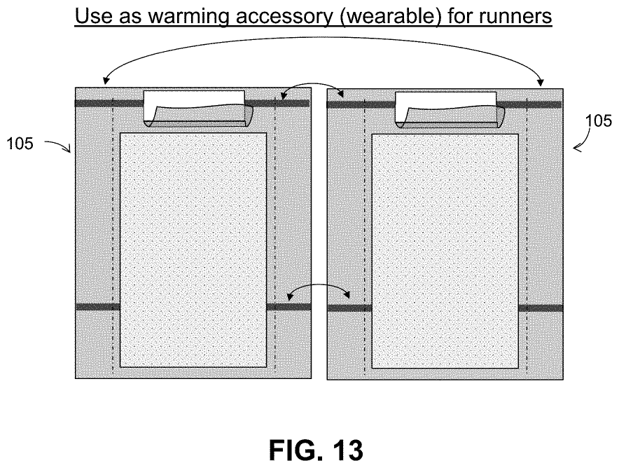

FIG. 13 illustrates an example cover pad 105 that may be utilized as a wearable warming accessory for a user. For example, during a race or fitness run in cold weather, a runner may require a wearable warming accessory for a short period during the start of the race, which he or she may choose to discard along the run or race. Runners typically use makeshift garbage covers with an opening for their head in such situations. FIG. 13 provides an elegant solution, wherein the user could use their cover pad 105 as warming accessory. As an example, the user could take two cover pads and attach them using the anti-slip tapes or bands to form a warming accessory, wherein the user may insert their head in the opening provided for the automobile head-rest, and wear the cover pads, such that one cover pad is in the front and one cover pad is in the back, which are then attached to each other using anti-slip tapes or bands.

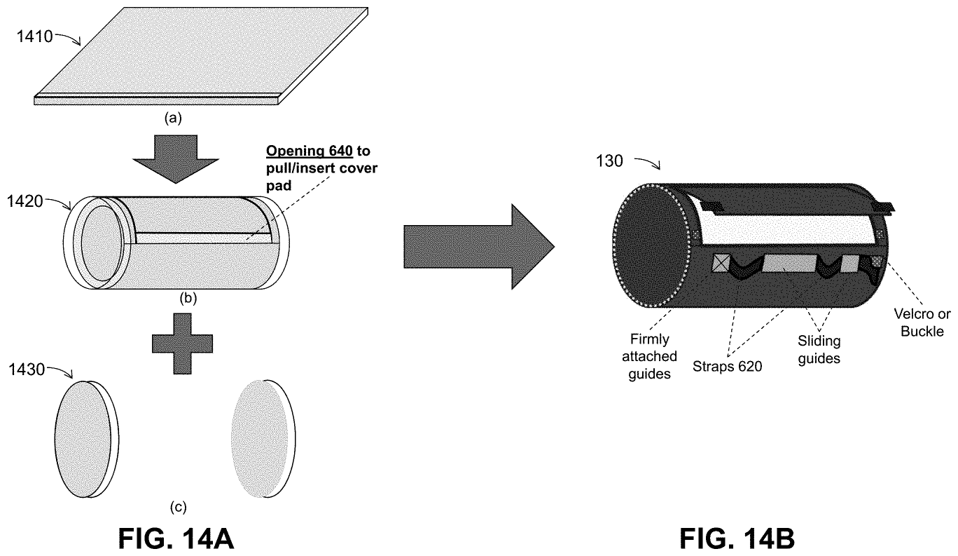

Referring now to FIGS. 14A and 14B, a method of manufacturing the dispenser 130 is illustrated, according to an embodiment of the disclosure. The method may begin at (a) of FIG. 14A, wherein an initial piece of carboard, plastic, leather, foam or leatherette sheet is laid down. The initial piece 1410 may have dimensions required to form the dispenser 130. The initial piece 1410 may also be formed of one or more layers of material, such as a piece of cardboard with a layer of foam over which a layer of vinyl is applied. The initial piece 1410 may then be formed into a hollow cylindrical structure 1420. Appropriate areas of the material may be removed to form the opening or slit 640 that may aid an user to pull and/or insert cover pads 105. The hollow cylindrical structure may be formed in a variety of ways, such as, by rolling the initial piece 1410 and then gluing the ends. Other means of attaching the ends, such as stapling, sewing, and so on may also be employed. The hollow cylindrical structure 1420 thus formed may then be attached to end caps 1430. The end caps may be made of a single material or they may be formed of two or more layers of material, like the cylindrical structure 1420.

FIG. 14B shows a completed example of a dispenser 130 after all the straps, guides, and Velcro has been attached to the structure formed in FIG. 14A.

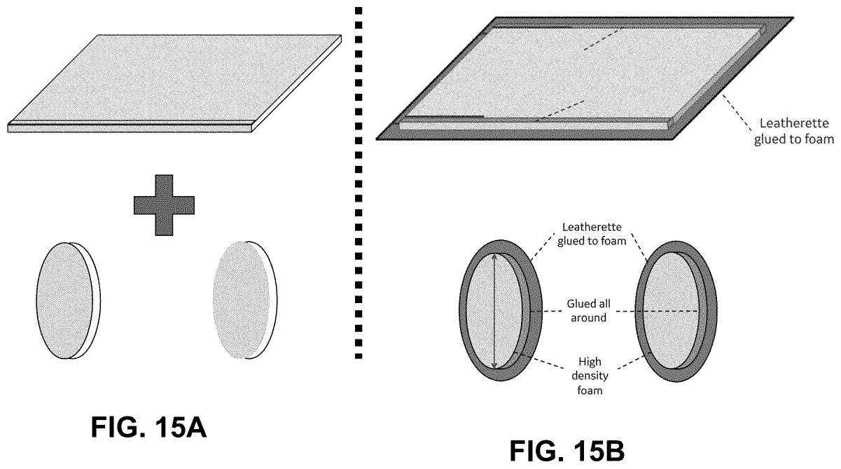

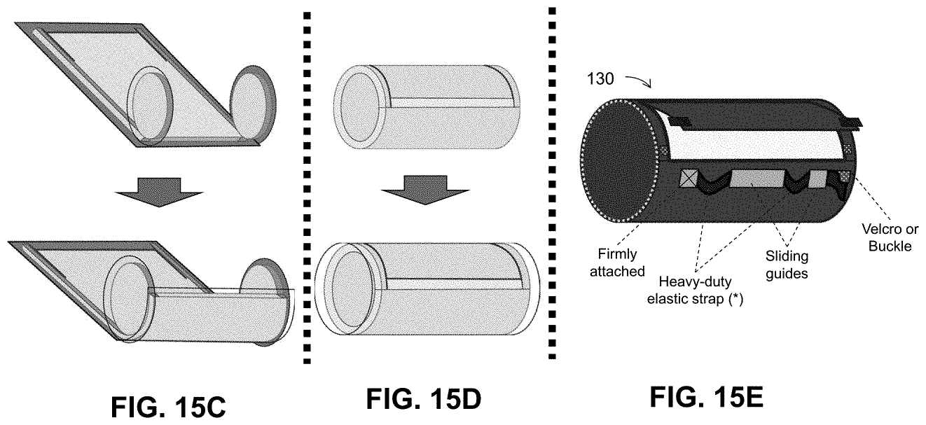

FIGS. 15A through 15E illustrate a variation of the method discussed with reference to FIGS. 14A and 14B. FIG. 15A through 15E illustrate a multi-layer material used to form the dispenser 130.

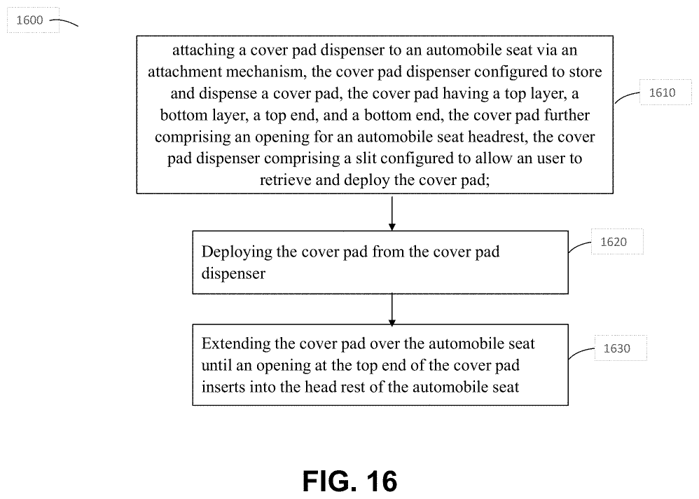

Referring now to FIG. 16, a flow diagram of an example method 1600 for a disposable automobile seat cover system is shown, according to an example embodiment of the disclosure. The method 1600 may be utilized in association with various systems, such as the system 100 illustrated in FIG. 1. In general, operations of disclosed processes (e.g., process 1600) may be performed in an arbitrary order, unless otherwise provided in the claims.

The method 1600 may begin at block 1610. At block 1610, a dispenser 130 may be attached to an automobile seat 205. As described in reference to FIG. 1, the dispenser 130 may be configured to store and dispense a cover pad 105, where the cover pad 105 may have a top layer, a bottom layer, a top end, and a bottom end. The cover pad 105 may further include an opening 140 for an automobile head rest. The dispenser 130 may include a slit or opening 640 to allow an user to retrieve and deploy the cover pad 105. Next, at block 1620, the method 1600 may include deploying the cover pad 105 from the cover pad dispenser 130. At block 1630, the method 1600 may further include extending the cover pad 105 over the automobile seat 205 until an opening 140 at the top end 120 of the cover pad 105 inserts into the head rest 210 of the automobile seat 205.

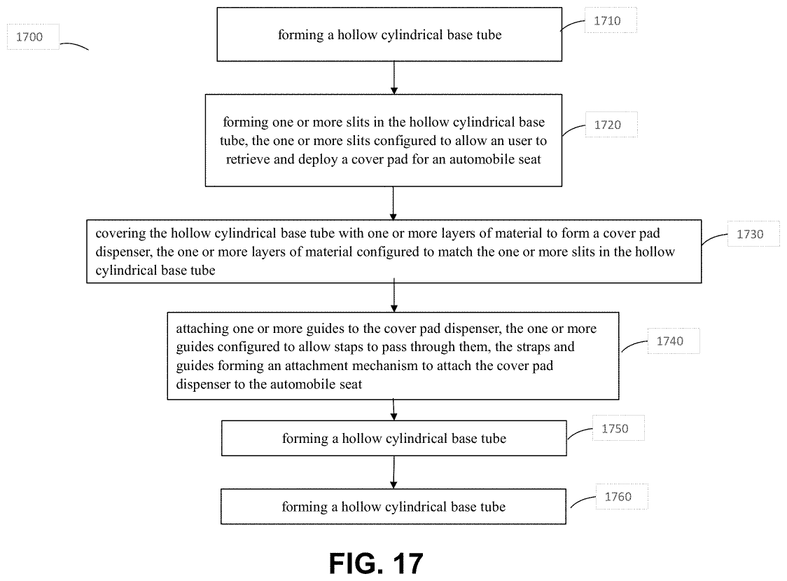

Referring now to FIG. 17, a flow diagram of another example method 1700 is illustrated, according to an embodiment of the disclosure. The method 1700 may be utilized in association with various systems, such as the system 100 illustrated in FIG. 1. In general, operations of disclosed processes (e.g., process 1700) may be performed in an arbitrary order, unless otherwise provided in the claims.

The method may begin at block 1710 by forming a hollow cylindrical base tube. The method may further include, at 1720, forming one or more slits 640 in the hollow cylindrical base tube, the one or more slits 640 configured to allow an user to retrieve and deploy a cover pad for an automobile seat. At 1730, the method may include covering the hollow cylindrical base tube with one or more layers of material to form a cover pad dispenser, the one or more layers of material configured to match the one or more slits in the hollow cylindrical base tube. The method may further include attaching (1740) one or more guides to the cover pad dispenser, the one or more guides configured to allow staps to pass through them, the straps and guides forming an attachment mechanism to attach the cover pad dispenser to the automobile seat. Then, end caps may be attached to both ends of the hollow cylindrical base tube at 1750. The method may end at 1760 wherein the end caps may be covered with one or more layers of material. The material may include, for example, vinyl, foam, cardboard or leather type materials.

It will be understood by those within the art that, in general, terms used herein, and are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Many modifications and other embodiments of the example descriptions set forth herein to which these descriptions pertain will come to mind having the benefit of the teachings presented in the foregoing descriptions and the associated drawings. Thus, it will be appreciated that the disclosure may be embodied in many forms and should not be limited to the example embodiments described above.

### CONCLUSION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

That which is claimed is:

1. A protective cover assembly for an automobile seat, comprising:
a cover pad for an automobile seat contoured to fit the automobile seat, the cover pad comprising a top layer, a bottom layer, a top end, and a bottom end, the cover pad further comprising an opening for an automobile seat headrest;
a dispenser attached to the automobile seat and configured to store and dispense the cover pad, the dispenser comprising a slit configured to allow an user to retrieve and deploy the cover pad; and
an attachment mechanism to attach the dispenser to the automobile seat.

2. The protective cover assembly of claim 1, wherein the attachment mechanism comprises at least one of: straps or hooks.

3. The protective cover assembly of claim 1, further comprising: an anti-slip band configured to reduce slippage of the cover pad from the automobile seat and disposed along one or more of: a width of the cover pad or length of the cover pad.

4. The protective cover assembly of claim 1, wherein the cover pad has perforated edges at the top end and perforated edges at the bottom end to detach from a second cover pad.

5. The protective cover assembly of claim 1, wherein the cover pad is made of a biodegradable material.

6. The protective cover assembly of claim 1, the slit formed on the cover pad is held with a Velcro attachment.

7. The protective cover assembly of claim 1, wherein the cover pad is configured to have foldable side wings.

8. The protective cover assembly of claim 1, wherein the dispenser comprises a hollow cylindrical base tube and caps at both ends of the hollow cylindrical tube, the hollow cylindrical base tube and caps at both ends covered by one or more layers of material.

9. The protective cover assembly of claim 8, wherein the hollow cylindrical tube and caps comprise at least one of: a cardboard layer, a foam layer, a plastic layer, a leather layer, a fabric layer or a vinyl layer.

10. A method, comprising:
attaching a cover pad dispenser to an automobile seat via an attachment mechanism, the cover pad dispenser configured to store and dispense a cover pad, the cover pad having a top layer, a bottom layer, a top end, and a bottom end, the cover pad further comprising an opening for an automobile seat headrest, the cover pad dispenser comprising a slit configured to allow a user to retrieve and deploy the cover pad;
deploying the cover pad from the cover pad dispenser; and
extending the cover pad over the automobile seat until an opening at the top end of the cover pad inserts into the head rest of the automobile seat.

11. The method of claim 10, further comprising: detaching the cover pad from a second cover pad via perforated edges at the top end of the cover pad and perforated edges at the bottom end of the second cover pad.

12. The method of claim 10, wherein laying the cover pad over the automobile seat further comprises: unfolding the cover pad along one or more foldable side wings.

13. The method of claim 10, wherein the attachment mechanism comprises at least one of: straps or hooks.

14. The method of claim 10, further comprising:
attaching the cover pad to the automobile seat via one or more anti-slip bands disposed on the cover pad.

15. A method, comprising:
forming a hollow cylindrical base tube;
forming one or more slits in the hollow cylindrical base tube, the one or more slits configured to allow an user to retrieve and deploy a cover pad for an automobile seat;
covering the hollow cylindrical base tube with one or more layers of material to form a cover pad dispenser, the one or more layers of material configured to match the one or more slits in the hollow cylindrical base tube;
attaching one or more guides to the cover pad dispenser, the one or more guides configured to allow straps to pass through them, the straps and guides forming an attachment mechanism to attach the cover pad dispenser to the automobile seat;
attaching end caps to both ends of the hollow cylindrical base tube; and
covering the end caps with the one or more layers of material;

16. The method of claim 15, wherein the hollow cylindrical base tube comprises at least one of: a cardboard material, a plastic material, a leather material, or a faux-leather material.

17. The method of claim 15, wherein the one or more layers of materials covering the hollow cylindrical base comprise at least one of: a vinyl material, a foam material, a leather material, or a faux-leather material.

18. The method of claim 15, wherein the one or more guides is attached to the cover pad dispenser via at least one of: glue, rivets, staples, or stitches.

19. The method of claim 15, wherein covering the hollow cylindrical base tube with one or more layers of material to form a cover pad dispenser comprises at least one of: gluing, stapling, or stitching the one or more layers of material over the hollow cylindrical base tube.

20. The method of claim 15, wherein attaching the end caps to both ends of the hollow cylindrical base tube comprises at least one of: gluing, stapling, or stitching the end caps to both ends of the hollow cylindrical base tube.
